(19) United States
(12) Patent Application Publication
(10) Pub. No.: US 2007/0040486 A1
(43) Pub. Date: Feb. 22, 2007

(54) Plasma display apparatus

(76) Inventor: Yeung-Ki Kim, Yongin-si (KR)

Correspondence Address: Robert E. Bushnell, Suite 300, 1522 K Street, N.W., Washington, DC, 20005, US

(21) Appl. No.: 11/500,515

(22) Filed: Aug. 8, 2006

(30) Foreign Application Priority Data
Aug. 17, 2005 (KR) 10-2005-0075162

(51) Int. Cl. H01J 61/52

(52) U.S. Cl. 313/46

(57) ABSTRACT

A plasma display apparatus. The plasma display apparatus uses a synthetic resin chassis base. A thin metal plate is attached between the panel and the chassis base and is connected to grounded terminals of the circuit portion and to an electromagnetic wave blocking direct-attachment filter on a front of the panel. Such a structure is advantageous in that as the synthetic chassis base is employed in the plasma display apparatus, it is possible to reduce the amount of material used and to reduce molding costs, to simplify processes, and to decrease the weight and noise of a module. Second, the plasma display apparatus has another advantage of securing a ground for the circuit portion and improving the stability of the plasma display panel module, as the thin metal plate can be electrically connected to the direct-attachment filter and perform the grounding function.

### CLAIM OF PRIORITY

This application makes reference to, incorporates the same herein, and claims all benefits accruing under 35 U.S.C. § 119 from an application for PLASMA DISPLAY APPARATUS earlier filed in the Korean Intellectual Property Office on 17 Aug. 2005 and there duly assigned Serial No. 10-2005-0075162.

### BACKGROUND OF THE INVENTION

1. Field of the Invention

The present invention relates to a plasma display apparatus, and more particularly to a plasma display apparatus which has a chassis base made out of synthetic resin instead of a metal such as aluminum, resulting in reduced total weight, reduced number of parts used, reduced noise, and reduced manufacturing costs, while improving workability. A thin metal plate can also be present to serve as a thin grounding plate while improving the electric connection and the grounding performance of the circuit portion and the panel.

2. Description of the Related Art

Recently, various flat display devices have been developed as a replacement for the cathode ray tube. Representative examples of such flat display devices include a liquid crystal display device, an electro-luminescence display device, a field emission display device, and a plasma display device. The plasma display device can display images via plasma discharge, and has an advantage in that it is possible to easily realize a fully digital image on a screen larger than that of other flat display devices.

The plasma display device includes a filter assembly, a panel, a heat conductive sheet, a chassis base, a circuit portion, a connection member, a protective plate, and additional members, which are located in front and rear cases. Among these items, the chassis base supports the panel positioned in the front thereof, while fixing the circuit portion at the rear thereof to drive the panel so that the panel can display the desired images. The chassis base not only functions as the supporting member, but also dissipates heat generated by the panel and circuit portion away from the plasma display device. Further, the chassis base is made out of aluminum, which is a metal material, so that the circuit portion can be electrically grounded. Recently, as the plasma display panel tends to become thinner, the chassis base is also required to be thinner. However, if the chassis base has smaller thickness, the chassis base may not be strong enough to support the panel. Thus, in order to prevent the chassis base from being twisted or bent because of its small thickness, a reinforcing material is attached to the rear surface of the chassis base in order to increase the strength of the chassis base.

On the other hand, as design capability for the circuit portion and the panel has progressed, recent plasma display panel modules tend to have reduced power consumption, reduced amount of electromagnetic waves, and a reduced level of heat. Further, there is much effort to replace an expensive chassis base made out of aluminum with an inexpensive chassis base made out of synthetic resin. A chassis base made out of synthetic resin has many advantages in that the chassis base can be produced by injection molding so that both the simplicity of making and manufacturing costs are reduced, the weight and noise of the plasma display panel module are reduced, and the consumer price is lower. However, even though the chassis base made out of synthetic resin resolves problems concerning the strength thereof, as well as the heat dissipating properties of the plasma display device, electrical grounding problems arise as synthetic resin is not conductive and thus can not be used to ground the circuit components mounted thereon. Therefore, what is needed is a design for a plasma display panel where a synthetic resin chassis base is used and where the circuit components mounted thereon can effectively be grounded.

### SUMMARY OF THE INVENTION

It is therefore an object of the present invention to provide an improved design for a plasma display apparatus.

It is also an object of the present invention to provide a plasma display apparatus having a synthetic resin chassis base where the electrical circuits within the apparatus can effectively be grounded.

These and other objects may be achieved by a plasma display apparatus which has a chassis base made out of synthetic resin instead of aluminum to reduce total weight, the number of parts used, and noise while decrease manufacturing cost and processes thereof, improve workability, the plasma display apparatus also having a thin metal plate and a thin grounding plate in order to improve an electrical connection and a grounding performance of a circuit portion and a panel.

According to one aspect of the present invention, there is provided a plasma display apparatus that includes a panel adapted to display images, a plurality of electrodes arranged with the panel, a chassis base adapted to support the panel, the chassis base comprising synthetic resin, a circuit portion adapted to operate the plurality of electrodes, the circuit portion comprising a plurality of grounded terminals and a plurality of circuit boards arranged on a rear surface of the chassis base, a thin metal plate arranged on a front surface of the chassis base and electrically connected to the plurality of grounded terminals and a direct-attachment filter arranged on a front surface of the panel and adapted to allow electric current to flow therein.

At least a part of the thin metal plate can extend to and be connected to the direct-attachment filter. The plasma display apparatus can also include a plurality of metal bosses arranged within the chassis base and extending through the chassis base and adapted to electrically connect the thin metal plate to the plurality of grounded terminals. The chassis base can include one of a polyester, an epoxy, and a polycarbonate resin. The thin metal plate can be spaced apart from the panel and extend to enclose at least an edge of the panel. wherein the thin metal plate covers opposite edges of the direct attachment filter and is attached to the direct attachment filter at a front surface of the direct attachment filter. The thin metal plate can include aluminum and have a thickness of 0.1 mm. The direct-attachment filter can have a width that is smaller than a width of the panel.

According to another aspect of the present invention, there is provided a plasma display apparatus that includes a panel adapted to display images, a plurality of electrodes arranged within the panel, a chassis base adapted to support the panel, the chassis base comprising synthetic resin, a circuit portion adapted to operate the plurality of electrodes, the circuit portion comprising a plurality of grounded terminals and a plurality of circuit boards arranged on a rear surface of the chassis base, a thin metal plate arranged on a front surface of the chassis base and electrically connected to the plurality of grounded terminals and a direct-attachment filter arranged on a front surface of the panel, the direct-attachment filter being adapted to filter out electromagnetic waves produced in the panel while being electrically connected to the thin metal plate.

The plasma display apparatus can also include a plurality of synthetic resin bosses adapted to attach the thin metal plate to the chassis base. The plasma display apparatus can also include a metal conductor arranged within each of the plurality of synthetic resin bosses, each metal conductor being adapted to electrically connect ones of the plurality of grounded terminals to the thin metal plate. The plasma display apparatus can also include an adhesive adapted to space apart the thin metal plate from the panel while being adapted to attach the thin metal plate to the panel. The adhesive can have gaps adapted to allow hot air from the panel to travel and escape from the plasma display apparatus. The thin metal plate can cover at least one edge of the panel.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded schematic perspective view of a plasma display apparatus according to an embodiment of the present invention; and

FIG. 2 is a schematic sectional view showing the plasma display apparatus of FIG. 1 according to the embodiment of the present invention.

### DETAILED DESCRIPTION OF THE INVENTION

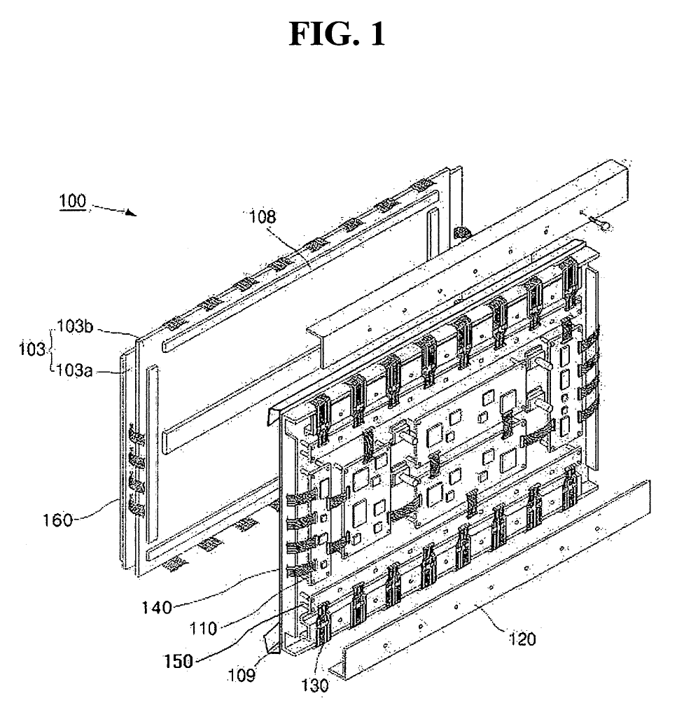

Turning now to the figures, FIG. 1 is an exploded schematic perspective view of a plasma display apparatus according to an embodiment of the present invention. Referring to FIG. 1, the plasma display apparatus 100 includes a panel 103, an adhesive member 108, a chassis base 109, a circuit portion 110, a protective plate 120, connection members 130, a thin metal plate 140, and a direct-attachment filter 160.

The panel 103 displays images by performing discharge depending upon operation signals transferred from a circuit element disposed on the circuit portion 110. The panel 103 has barriers, electrodes, a fluorescent material, a dielectric material, and a protective layer formed between two substrates 103a and 103b. Further, the panel 103 has discharge cells, which are defined by the substrates 103a and 103b, and the barriers. Within the discharge cells, the discharge occurs. These discharge cells are filled with inert gases which produce ultra-violet rays that excite the fluorescent material when the discharge is created within the discharge cells. This panel 103 is connected to the circuit portion 110 by means of a flexible printed circuit or a tape carrier package in the form of a chip-on-film containing a driving chip.

The panel 103 is fixed by the adhesive member 108 to the thin metal plate 140 attached to the front surface of the chassis base 109. To do this, the adhesive member 108 adheres to edge and center portions of the panel 103 in a formation of a band or frame, and fixes the panel 103 to the thin metal plate 140 attached to the chassis base 109. An adhesive agent, an adhesive sheet, or an adhesive tape may be used as the adhesive member 108. It is preferred to use various adhesive members having different thicknesses, different shapes and different adhering methods based on the characteristics of the chassis base 109. When the chassis base is made out of synthetic resin having poor heat dissipating characteristics and low heat conductivity, it is preferred to space the adhesive members 108 at certain distances from each other. The reason for this spacing is to allow enough space for air to flow through gaps between the adhesive members 108 so that heat can be easily dissipated from the panel 103. Furthermore, in order to improve the dissipation of heat, the adhesive member 108 is preferably sufficiently thick so as to provide for sufficient space in the gaps through which air can flow between the panel 103 and the chassis base 109.

The thin metal plate 140 is attached to the front surface of the chassis base 109, on which the panel 103 is fixed to the thin metal plate 140 by means of the adhesive member 108. Then, the circuit portion 110 is supported on and fixed to the rear surface of the chassis base 109 by the bosses 150 and bolts or screws 112/114. In the present invention, since the chassis base 109 is made out of synthetic resin, a problem occurs as to how to electrically ground the circuit portion 110.

The circuit portion 110 has a plurality of boards to operate the plasma display panel. Specifically, the circuit portion 110 includes a power supplying portion, a logic circuit portion, an address circuit portion, a scan circuit portion, a sustain circuit portion, and driving buffer boards. The power supplying portion supplies electrical power to driving circuits and to the panel and contains an AC/DC converter to convert alternating current into direct current. The logic circuit portion receives and divides image signals into signals that are transferred to the address circuit portion, the scan circuit portion, and the sustain circuit portion, while controlling signals and electric power. Each circuit portion transfers signals from the logic circuit to each driving chip. Each driving chip distributes signals via the logic circuit portion to each electrode. The driving buffer boards are installed between each circuit portion and the panel 103. The driving signal of each circuit portion is supplied to the panel 103 by way of the driving buffer boards. In addition, the driving buffer boards are connected to the panel 103 by means of a tape carrier package or a flexible printed circuit.

Since the circuit portion 110 requires a high voltage in order to apply appropriate voltages to the electrodes within the panel 103, it is necessary to stably ground the circuit portion 110. Since the chassis base 109 is made out of synthetic resin which is not a conductor, merely electrically connecting the circuit portion 110 to the chassis base 109 would not serve to ground circuit portion 110. Some other mechanism needs to be present to ground the circuit portion 110 when the chassis base 109 is made out of synthetic resin.

The protective plate 120 protects the connection members 130 from external impact along with front and rear cases and transfers heat from the connection members 130 to a heat dissipating member (not shown). In addition, the protective plate 120 directly dissipates heat so as to prevent the connection members 130 from being damaged.

In the plasma display apparatus of the present invention, the thin metal plate 140 is attached to the front surface of the chassis base 109 and is electrically connected to grounded portions of the circuit portion 110 in order to perform a grounding function. The grounding function of the thin metal plate 140 will be described below.

The direct-attachment filter 160 is attached to the front surface of the panel 103 and is electrically connected to the thin metal plate 140 so as to reinforce the grounding function of the thin metal plate 140. The operation of the direct-attachment filter 160 will also be described below.

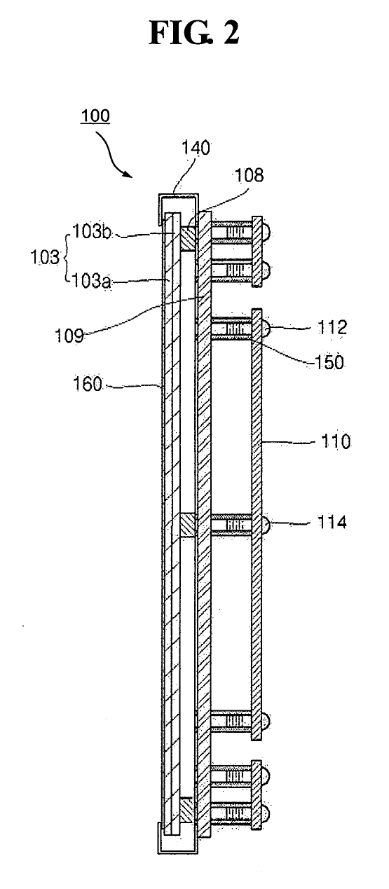

Turning now to FIG. 2, FIG. 2 is a schematic sectional view showing the plasma display apparatus 100 of FIG. 1 according to the present invention. As in FIG. 1, the plasma display apparatus 100 of FIG. 2 shows an electric connection between the circuit portion 110, the thin metal plate 140, and the direct-attachment filter 160.

Referring to FIG. 2, the panel 103 of the plasma display apparatus 100 includes panel 103 attached to the thin metal plate 140 located on the synthetic resin chassis base 109 by the adhesive member 108. The circuit portion 110 is attached to chassis base 109 by bosses 150 and screws 112/114 that are fixed to the thin metal plate 140 and extend through the chassis base 109. The thin metal plate 140 is electrically connected to the direct-attachment filter 160 located on the front surface of the panel 103. Thin metal plate 140 grounds the direct-attachment filter 160 so as to reinforce its grounding function.

Here, the chassis base 109 is made out of synthetic resin such as polyester, epoxy, or polycarbonate resin. When polyester resin is used, it is generally reinforced with fiber so that it is considered a “fiber reinforced plastic.” It is possible to manufacture fiber reinforced plastic having a strength similar to that of steel by using a recently developed molding method. On the other hand, polycarbonate resin is a non-toxic engineering synthetic resin that is transparent and has excellent mechanical characteristics, heat resistance, and self-extinguishing properties. However, it is understood that the material of the chassis base 109 is not limited to the above-mentioned resins.

If the chassis base 109 has poor heat conductivity and poor heat dissipating characteristics because it is made out of synthetic resin. It is preferred that the chassis base 109 is spaced apart by a desired distance from the panel 103 by the adhesive member 108. Further, the thin metal plate 140 is electrically connected to the grounded portions of the circuit portion 110 so as to perform a grounding function. The electric connection between the chassis base 109 and the circuit portion 110 will be described below.

The bosses 150 are fixed at one end thereof to the thin metal plate 140, of which the other end extends through the chassis base 109 and is electrically connected to the grounded portion of the circuit portion 110. Also, the ends of the bosses 150 are electrically connected to each other so that the thin metal plate 140 can perform the grounding function. At this time, the thin metal plate 140 extends outward from opposite sides and over opposite sides of the chassis base 109 and is spaced around edges of the panel 103 to cover the edges of the panel 103. Further, the thin metal plate 140 is connected to and covers one end or both ends of the direct-attachment filter 160 attached to the panel 103. Here, the thin metal plate 140 has a thickness of 0.1 mm and is preferably made out of aluminum.

The bosses 150, electrically connecting the thin metal plate 140 to the grounded portion of the circuit portion 110, can be made out of conductive material or out of a synthetic resin. When the bosses 150 are made out of synthetic resin, the bosses 150 must also include a conductive material that electrically connects the ends of each boss together. When the bosses 150 are made out of synthetic resin, the bosses 150 can be integrally formed with the chassis base 109. Accordingly, separate fixing members are unnecessary, and processing time and process costs can be reduced. The bosses 150 can be molded in an insertion manner and fixed to the chassis base 109 during the injection-molding of the chassis base 109, or can be fixed to the chassis base 109 by using fixing members or screws 112/114 after injection-molding of the chassis base 109.

The direct-attachment filter 160 is attached to the front surface of the panel 103, is connected to the thin metal plate 140 and is applied current so that the direct-attachment filter 160 can absorb electromagnetic waves generated by the plasma display panel while preventing static electricity from occurring on the panel. The direct-attachment filter 160 preferably has a width narrower than that of the panel 103.

The present invention has been described with relation to the plasma display panel, but may also be applied to other flat display devices. The plasma display apparatus according to the present invention first has an advantage in that when a synthetic resin chassis base is employed in a plasma display apparatus, it is possible to reduce the amount of material used and the molding costs, to simplify making, and to decrease the weight and noise of a device. Second, since the direct-attachment filter is attached to the front surface of the panel while the thin metal plate is spaced at a predetermined distance from the panel and attached to the front surface of the chassis base, the thin metal plate can be electrically connected to the direct-attachment filter and perform the grounding function, thus securing the electrical ground while improving the stability of the plasma display panel module.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A plasma display apparatus, comprising:
a panel adapted to display images;
a plurality of electrodes arranged with the panel;
a chassis base adapted to support the panel, the chassis base comprising synthetic resin;
a circuit portion adapted to operate the plurality of electrodes, the circuit portion comprising a plurality of grounded terminals and a plurality of circuit boards arranged on a rear surface of the chassis base;
a thin metal plate arranged on a front surface of the chassis base and electrically connected to the plurality of grounded terminals; and
a direct-attachment filter arranged on a front surface of the panel and adapted to allow electric current to flow therein.

2. The plasma display apparatus of claim 1, wherein at least a part of the thin metal plate extends to and is connected to the direct-attachment filter.

3. The plasma display apparatus of claim 1, further comprising a plurality of metal bosses arranged within the chassis base and extending through the chassis base and adapted to electrically connect the thin metal plate to the plurality of grounded terminals.

4. The plasma display apparatus of claim 1, wherein the chassis base comprises a resin selected from the group consisting of polyester, epoxy, and polycarbonate resins.

5. The plasma display apparatus of claim 2, wherein the thin metal plate is spaced apart from the panel and extends to enclose at least an edge of the panel.

6. The plasma display apparatus of claim 2, wherein the thin metal plate covers opposite edges of the direct-attachment filter and is attached to the direct-attachment filter at a front surface of the direct-attachment filter.

7. The plasma display apparatus of claim 5, wherein the thin metal plate covers opposite edges of the direct-attachment filter and is attached to the direct-attachment filter at a front surface of the direct-attachment filter.

8. The plasma display apparatus of claim 1, wherein the thin metal plate comprises aluminum and has a thickness of 0.1 mm.

9. The plasma display apparatus of claim 1, wherein the direct-attachment filter has a width that is smaller than a width of the panel.

10. A plasma display apparatus, comprising:
a panel adapted to display images;
a plurality of electrodes arranged within the panel;
a chassis base adapted to support the panel, the chassis base comprising synthetic resin;
a circuit portion adapted to operate the plurality of electrodes, the circuit portion comprising a plurality of grounded terminals and a plurality of circuit boards arranged on a rear surface of the chassis base;
a thin metal plate arranged on a front surface of the chassis base and electrically connected to the plurality of grounded terminals; and
a direct-attachment filter arranged on a front surface of the panel, the direct-attachment filter being adapted to filter out electromagnetic waves produced in the panel while being electrically connected to the thin metal plate.

11. The plasma display apparatus of claim 10, further comprising a plurality of synthetic resin bosses adapted to attach the thin metal plate to the chassis base.

12. The plasma display apparatus of claim 10, further comprising a metal conductor arranged within each of the plurality of synthetic resin bosses, each metal conductor being adapted to electrically connect ones of the plurality of grounded terminals to the thin metal plate.

13. The plasma display apparatus of claim 10, further comprising an adhesive adapted to space apart the thin metal plate from the panel while being adapted to attach the thin metal plate to the panel.

14. The plasma display apparatus of claim 13, the adhesive having gaps adapted to allow hot air from the panel to travel and escape from the plasma display apparatus.

15. The plasma display apparatus of claim 10, the thin metal plate covering at least one edge of the panel.
